(19) United States
(12) Patent Application Publication
(10) Pub. No.: US 2015/0022121 A1
(43) Pub. Date: Jan. 22, 2015

(54) LIGHT-EMITTING CONTROL CIRCUIT AND ELECTRONIC DEVICE USING THE SAME

(71) Applicants: HONG FU JIN PRECISION INDUSTRY (ShenZhen) CO., LTD., Shenzhen (CN); HON HAI PRECISION INDUSTRY CO., LTD., New Taipei (TW)

(72) Inventors: LU-QING MENG, Shenzhen (CN); CHUN-LUNG HUNG, New Taipei (TW)

(21) Appl. No.: 14/334,924

(22) Filed: Jul. 18, 2014

(30) Foreign Application Priority Data
Jul. 19, 2013 (CN) 2013103046642

(51) Int. Cl. H05B 37/02

(52) U.S. Cl. CPC H05B 37/02
USPC 315/311

(57) ABSTRACT

A light-emitting control circuit includes a light-emitting unit, a switch module, a driving unit, a first energy storage unit, and a second energy storage unit. The driving unit outputs a first signal to turn on the switch module, and outputs a second signal to turn off the switch module. The power supply provides power to charge the first energy storage unit when the switch module is turned on, an electric conductivity of the switch module accordingly gradually increases, and the voltage across the light-emitting unit accordingly gradually increases, causing the light emitted by the light-emitting unit to gradually become brighter. The second energy storage unit discharges to provide voltage to the light-emitting unit when the switch module is turned off, the light emitted by the light-emitting unit gradually becomes darker.

### CROSS-REFERENCE TO RELATED APPLICATIONS

This application claims priority to Chinese Patent Application No. 201310304664.2 filed on Jul. 17, 2013 in the China Intellectual Property Office, the contents of which are incorporated by reference herein.

### FIELD

The subject matter herein generally relates to light-emitting control circuits, and particularly, to a light-emitting control circuit capable of providing amusement and a related electronic device.

### BACKGROUND

Light emitting diodes (LEDs) have many advantages, such as low energy consumption, long lifetime, improved physical robustness, small size, and fast switching. LEDs are commonly used as indicator lamps for electronic devices.

### BRIEF DESCRIPTION OF THE DRAWINGS

Implementations of the present technology will now be described, by way of example only, with reference to the attached figures.

FIG. 1 illustrates a block diagram of an embodiment of an electronic device.

FIG. 2 illustrates a circuit diagram of the electronic device of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The connection can be such that the objects are permanently connected or releasably connected. The term “comprising” means “including, but not necessarily limited to”; it specifically indicates open-ended inclusion or membership in a so-described combination, group, series and the like.

Embodiments of the present disclosure will be described with reference to the accompanying drawings.

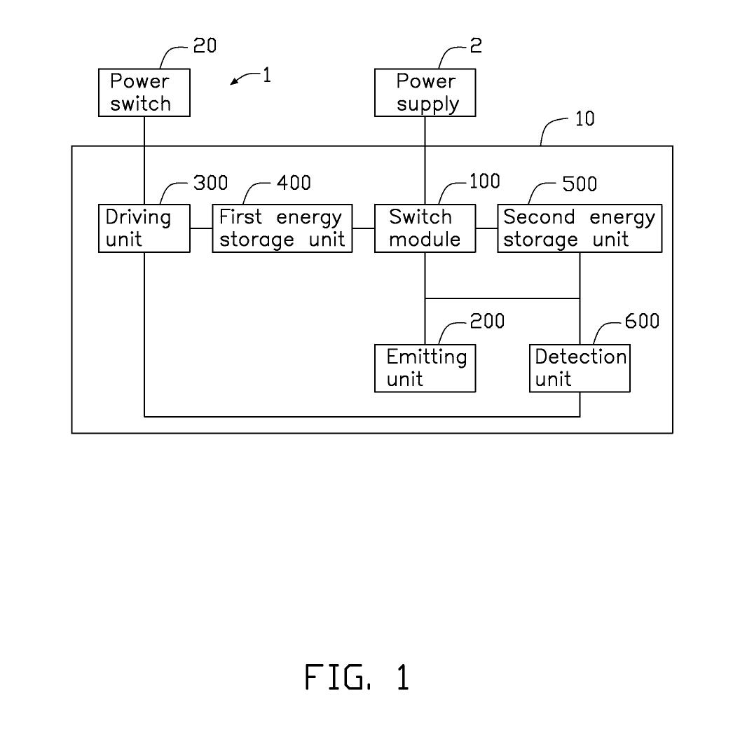

FIG. 1 illustrates a block diagram of an embodiment of an electronic device 1. The electronic device 1 can include a light-emitting control circuit 10. The light-emitting control circuit 10 can be coupled to a power supply 2 and can receive power from the power supply 2. The light-emitting control circuit 10 can include a switch module 100, a light-emitting unit 200, a driving unit 300, a first energy storage unit 400, and a second energy storage unit 500. The switch module 100 can be coupled between the power supply 2 and the light-emitting unit 200, and is used to control a connection between the power supply 2 and the light-emitting unit 200. When the switch module 100 is turned on, the connection between the power supply 2 and the light-emitting unit 200 is established. When the switch module 100 is turned off, the connection between the power supply 2 and the light-emitting unit 200 is cut off.

The driving unit 300 can be used to output a first signal to turn on the switch module 100, and output a second signal to turn off the switch module 100. In the embodiment, the first signal is a high level, and the second signal is a low level.

The first energy storage unit 400 can be coupled between the driving unit 300 and the switch module 100, and is coupled to the power supply 2 via the switch module 100. When the switch module 100 is turned on, the power supply 2 can provide power to charge the first energy storage unit 400, and simultaneously the voltage provided to the switch module 100 can gradually increase. An electric conductivity of the switch module 100 can gradually increase accordingly. Thus, a current drawn by the switch module 100 can gradually increase, and a voltage provided by the power supply 2 across the light-emitting unit 200 can gradually increase. The light-emitting unit 200 can emit light and the light emitted by the light-emitting unit 200 can gradually become brighter. When the switch module 100 is turned off, the power supply 2 can stop providing power to the first energy storage unit 400, and the first energy storage unit 400 can discharge immediately.

The second energy storage unit 500 can be coupled between the switch module 100 and the light-emitting unit 200. When the switch module 100 is turned on, the power supply 2 can provide power to charge the second energy storage unit 500. When the switch module 100 is turned off, the second energy storage unit 500 can discharge to provide voltage to the light-emitting unit 200, and the voltage provided by the second energy storage unit 500 can gradually decrease when the second energy storage unit 500 discharges. The light emitted by the light-emitting unit 200 can accordingly gradually become darker.

In a first embodiment, the light-emitting control circuit 10 can include a detection unit 600. The detection unit 600 can be coupled between the second energy storage unit 500 and the driving unit 300. The detection unit 600 can be configured to detect the voltage of the second energy storage unit 500, and output a first control signal or a second control signal to the driving unit 300 according to the detected voltage of the second energy storage unit 500, to control the driving unit 300 to output the first signal or the second signal to the switch module 100.

In a second embodiment, the light-emitting control circuit 10 can include a detection unit 600. The detection unit 600 can be coupled to the driving unit 300 and can be used to detect the power on or the power off the electronic device 1. The detection unit 600 can output a first control signal to the driving unit 300 when the electronic device 1 is powered on, to control the driving unit 300 to output the first signal to the switch module 100. The detection unit 600 can output a second control signal to the driving unit 300 when the electronic device 1 is powered off, to control the driving unit 300 to output the second signal to the switch module 100.

In a third embodiment, the driving unit 300 can be coupled to a power switch 20 of the electronic device 1. When the electronic device 1 is turned on, the power switch 20 can output a first control signal, such as a high level, to the driving unit 300, and the driving unit 300 can output the first signal to the switch module 100 in response to the first control signal output by the power switch 20. When the electronic device 1 is turned off, the power switch 20 can output a second control signal, such as a low level, to the driving unit 300, and the driving unit 300 can output the second signal to the switch module 100 in response to the second control signal output by the power switch 20.

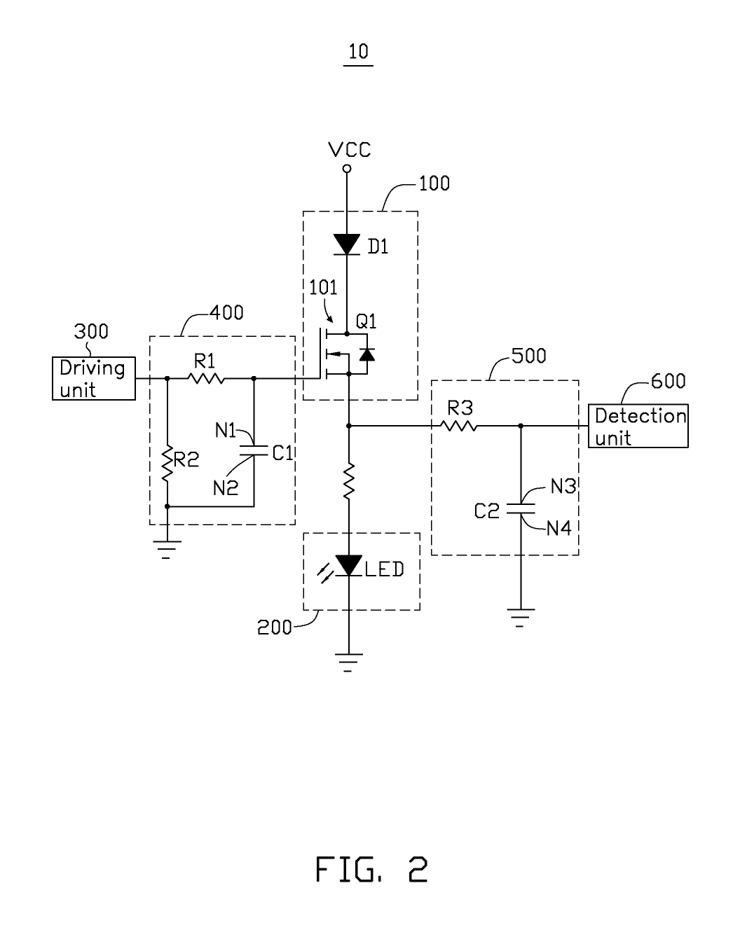

FIG. 2 illustrates a circuit diagram of an example embodiment of the electronic device 1.

In at least one embodiment, the switch module 100 can include a high voltage activated switch 101 and a diode D1. In the embodiment, an n-channel metal-oxide-semiconductor field-effect transistor (NMOSFET) Q1 is taken as an example to illustrate the high voltage activated switch 101. A source of the NMOSFET Q1 can be coupled to an intersection between the light-emitting unit 200 and the second energy storage unit 500. A gate of the NMOSFET Q1 can be coupled to the first energy storage unit 400. A drain of the NMOSFET Q1 can be coupled to the power supply 2 via the diode D1. In the embodiment, an anode of the diode D1 can be coupled to the power supply 2, and a cathode of the diode D1 can be coupled to the drain of the NMOSFET Q1.

The light-emitting unit 200 can be a light emitting diode (LED). An anode of the LED can be coupled to the source of the NMOSFET Q1, and a cathode of the LED can be grounded. In another embodiment, the light-emitting unit 200 can includes a number of LEDs coupled between the source of the NMOSFET Q1 and ground in series.

The first energy storage unit 400 can include a first resistor R1, a second resistor R2, and a first capacitor C1. A first terminal N1 of the first capacitor C1 can be coupled to the driving unit 300 via the first resistor R1 and can be coupled to the gate of the NMOSFET Q1, and a second terminal N2 of the first capacitor C1 can be grounded and can be coupled to the driving unit 300 via the second resistor R2.

The second energy storage unit 500 can include a third resistor R3 and a second capacitor C2. A first terminal N3 of the second capacitor C2 can be coupled to an intersection between the source of the NMOSFET Q1 and the anode of the LED via the third resistor R3, and a second terminal N4 of the second capacitor C2 can be grounded.

When the driving unit 300 outputs the high level to the gate of the NMOSFET Q1, a voltage difference between the gate of the NMOSFET Q1 and the source of the NMOSFET Q1 is greater than a cut-in voltage of the NMOSFET Q1, causing the NMOSFET Q1 to be turned on. The power supply 2 can charge the first capacitor C1 and the second capacitor C2 via the NMOSFET Q1 which is turned on, the voltage of the first terminal N1 of the first capacitor C1 can accordingly gradually increase, and the voltage of the gate of the NMOSFET Q1 connected to the first terminal N1 of the first capacitor C1 can accordingly gradually increase, causing the electric conductivity of the NMOSFET Q1 to increase. Simultaneously, the connection between the power supply 2 and the light-emitting unit 200 is established. The current drawn by the NMOSFET Q1 can increase, and the voltage provided by the power supply 2 across the light-emitting unit 200 can increase, thus the light-emitting unit 200 can emit light and the light emitted by the light-emitting unit 200 can gradually become brighter.

When the driving unit 300 outputs the low level to the gate of the NMOSFET Q1, the first capacitor C1 can discharge via the first resistor R1 and the second resistor R2, the voltage difference between the gate of the NMOSFET Q1 and the source of the NMOSFET Q1 can become less than the cut-in voltage of the NMOSFET Q1, the NMOSFET Q1 can accordingly be turned off, the connection between the power supply 2 and the light-emitting unit 200 is cut off. The second capacitor C2 can discharge to provide voltage to the light-emitting unit 200 and the provided voltage by the second capacitor C2 can gradually decrease. The light-emitting unit 200 can emit light and the light emitted by the light-emitting unit 200 can gradually become darker when the second capacitor C2 is discharged.

In the first embodiment, a first end of the detection unit 600 can be coupled to an intersection between the first terminal N3 of the second capacitor C2 and the third resistor R3, and a second end of the detection unit 600 can be coupled to the driving unit 300. The detection unit 600 can be configured to detect the voltage of the first terminal N3 of the second capacitor C2, and output the first control signal or the second control signal to the driving unit 300 according to the detected voltage of the first terminal N3 of the second capacitor C2, to control the driving unit 300 to output the high level or the low level to the gate of the NMOSFET Q1. In detail, when the voltage of the first terminal N3 of the second capacitor C2 detected by the detection unit 600 is less than a first predetermined value, such as 0.5 volt, namely, the second capacitor C2 can be completely discharged, the detection unit 600 can output the first control signal to the driving unit 300 to control the driving unit 300 to output the high level to the gate of the NMOSFET Q1. When the voltage of the first terminal N3 of the second capacitor C2 detected by the detection unit 600 is greater than a second predetermined value, such as 4 volts, namely, the second capacitor C2 can be charged finished, the detection unit 600 can output the second control signal to the driving unit 300, to control the driving unit 300 to output the low level to the gate of the NMOSFET Q1. In the first embodiment, the second predetermined value is greater than the first predetermined value.

In the second embodiment, the detection unit 600 can output the first control signal to the driving unit 300 when the electronic device 1 is powered on, to control the driving unit 300 to output the high level to the gate of the NMOSFET Q1. The detection unit 600 can output a second control signal to the driving unit 300 when the electronic device 1 is powered off, to control the driving unit 300 to output the low level to the gate of the NMOSFET Q1.

In the third embodiment, the power switch 20 can output a first control signal to the driving unit 300 when the electronic device 1 is turned on, to control the driving unit 300 to output the high level to the gate of the NMOSFET Q1. The power switch 20 can further output a second control signal to the driving unit 300 when the electronic device 1 is turned off, to control the driving unit 300 to output the low level to the gate of the NMOSFET Q1.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A light-emitting control circuit comprising:
a light-emitting unit;
a switch module coupled between a power supply and the light-emitting unit; a connection between the power supply and the light-emitting unit being established when the switch module is turned on; and the connection between the power supply and the light-emitting unit being cut off when the switch module is turned off;
a driving unit configured to output a first signal to turn on the switch module, and output a second signal to turn off the switch module;
a first energy storage unit coupled between the driving unit and the switch module; the power supply providing power to charge the first energy storage unit when the switch module is turned on; and the power supply stops providing power to the first energy storage unit when the switch module is turned off, and the first energy storage unit discharging immediately; and
a second energy storage unit coupled between the switch module and the light-emitting unit; the power supply providing power to charge the second energy storage unit when the switch module is turned on; and the second energy storage unit discharging to provide voltage to the light-emitting unit when the switch module is turned off;
wherein the voltage provided by the first energy storage unit to the switch module gradually increases when the power supply provides power to charge the first energy storage unit, an electric conductivity of the switch module gradually increases, the current drawn by the switch module gradually increases, and the voltage provided by the power supply across the light-emitting unit gradually increases, causing the light-emitting unit to emit and the light emitted by the light-emitting unit to gradually become brighter; and
wherein the voltage provided by the second energy storage unit gradually decreases when the second energy storage unit discharges, the light emitted by the light-emitting unit accordingly gradually becomes darker.

2. The light-emitting control circuit as described in claim 1, wherein the light-emitting control circuit comprises a detection unit; the detection unit is coupled between the second energy storage unit and the driving unit; and the detection unit is configured to detect the voltage of the second energy storage unit, and output a first control signal or a second control signal to the driving unit according to the detected voltage of the second energy storage unit, to control the driving unit to output the first signal or the second signal to the switch module.

3. The light-emitting control circuit as described in claim 1, wherein the light-emitting control circuit comprises a detection unit; the detection unit is coupled to the driving unit and configured to detect the power on or the power off the electronic device; the detection unit outputs a first control signal to the driving unit when the electronic device is powered on, to control the driving unit to output the first signal to the switch module; and the detection unit outputs a second control signal to the driving unit when the electronic device is powered off, to control the driving unit to output the second signal to the switch module.

4. The light-emitting control circuit as described in claim 1, wherein the switch module comprises a high voltage activated switch, a first terminal of the high voltage activated switch is coupled to an intersection between the light-emitting unit and the second energy storage unit, a second terminal of the high voltage activated switch is coupled to the first energy storage unit, and a third terminal of the high voltage activated switch is coupled to the power supply.

5. The light-emitting control circuit as described in claim 4, wherein the high voltage activated switch is an n-channel metal-oxide-semiconductor field-effect transistor (NMOSFET) Q1; a source of the NMOSFET Q1 is coupled to an intersection between the light-emitting unit and the second energy storage unit; a gate of the NMOSFET Q1 is coupled to the first energy storage unit; and a drain of the NMOSFET Q1 is coupled to the power supply.

6. The light-emitting control circuit as described in claim 5, wherein the first energy storage unit comprises a first resistor R1, a second resistor R2, and a first capacitor C1; a first terminal N1 of the first capacitor C1 is coupled to the driving unit via the first resistor R1 and is coupled to the gate of the NMOSFET Q1, and a second terminal N2 of the first capacitor C1 is grounded and is coupled to the driving unit via the second resistor R2.

7. The light-emitting control circuit as described in claim 5, wherein the light-emitting unit is a light emitting diode, an anode of the light emitting diode is coupled to the source of the NMOSFET Q1, and a cathode of the light emitting diode is grounded.

8. The light-emitting control circuit as described in claim 7, wherein the second energy storage unit comprises a third resistor R3 and a second capacitor C2; a first terminal N3 of the second capacitor C2 is coupled to an intersection between the source of the NMOSFET Q1 and the anode of the light-emitting unit via the third resistor R3, and a second terminal N4 of the second capacitor C2 can be grounded.

9. The light-emitting control circuit as described in claim 8, wherein the light-emitting control circuit further comprises a detection unit; a first end of the detection unit is coupled to an intersection between the first terminal N3 of the second capacitor C2 and the third resistor R3, and a second end of the detection unit is coupled to the driving unit; the detection unit is configured to detect the voltage of the first terminal N3 of the second capacitor C; the detection unit is configured to output a first control signal to the driving unit when the voltage of the first terminal N3 of the second capacitor C2 detected by the detection unit is less than a first predetermined value, to control the driving unit to output the first signal to the gate of the NMOSFET Q1; and the detection unit is configured to output the second control signal to the driving unit when the voltage of the first terminal N3 of the second capacitor C2 detected by the detection unit is more than a second predetermined value, to control the driving unit to output the second signal to the gate of the NMOSFET Q1.

10. An electronic device comprising:
an light-emitting control circuit comprising:
an light-emitting unit;
a switch module coupled between a power supply and the light-emitting unit; a connection between the power supply and the light-emitting unit being established when the switch module is turned on; and the connection between the power supply and the light-emitting unit being cut off when the switch module is turned off;
a driving unit configured to output a first signal to turn on the switch module, and output a second signal to turn off the switch module;
a first energy storage unit coupled between the driving unit and the switch module; the power supply providing power to charge the first energy storage unit when the switch module is turned on; and the power supply stops providing power to the first energy storage unit when the switch module is turned off, and the first energy storage unit discharging immediately; and
a second energy storage unit coupled between the switch module and the light-emitting unit; the power supply providing power to charge the second energy storage unit when the switch module is turned on; and the second energy storage unit discharging to provide voltage to the light-emitting unit when the switch module is turned off;
wherein the voltage provided by the first energy storage unit to the switch module gradually increases when the power supply provides power to charge the first energy storage unit, an electric conductivity of the switch module gradually increases, the current drawn by the switch module gradually increases, and the voltage provided by the power supply across the light-emitting unit gradually increases, causing the light-emitting unit to emit and the light emitted by the light-emitting unit to gradually become brighter; and
wherein the voltage provided by the second energy storage unit gradually decreases when the second energy storage unit discharges, the light emitted by the light-emitting unit accordingly gradually becomes darker.

11. The electronic device as described in claim 10, wherein the light-emitting control circuit comprises a detection unit; the detection unit is coupled between the second energy storage unit and the driving unit; and the detection unit is configured to detect the voltage of the second energy storage unit, and output a first control signal or a second control signal to the driving unit according to the detected voltage of the second energy storage unit, to control the driving unit to output the first signal or the second signal to the switch module.

12. The electronic device 1 as described in claim 10, wherein the light-emitting control circuit comprises a detection unit; the detection unit is coupled to the driving unit; the detection unit is configured to detect the power on or the power off the electronic device; the detection unit outputs a first control signal to the driving unit when the electronic device 1 is powered on, to control the driving unit to output the first signal to the switch module; and the detection unit outputs a second control signal to the driving unit when the electronic device is powered off, to control the driving unit to output the second signal to the switch module.

13. The electronic device as described in claim 10, wherein electronic device comprises a power switch; the driving unit is coupled to the power switch; the power switch outputs a first control signal to the driving unit when the electronic device is turned on, and the driving unit outputs the first signal to the switch module in response to the first control signal output by the power switch; and the power switch outputs a second control signal to the driving unit when the electronic device is turned off, and the driving unit outputs the second signal to the switch module in response to the second control signal output by the power switch.

14. The electronic device as described in claim 10, wherein the switch module comprises a high voltage activated switch, a first terminal of the high voltage activated switch is coupled to an intersection between the light-emitting unit and the second energy storage unit, a second terminal of the high voltage activated switch is coupled to the first energy storage unit, and a third terminal of the high voltage activated switch is coupled to the power supply.

15. The electronic device as described in claim 14, wherein the high voltage activated switch is an n-channel metal-oxide-semiconductor field-effect transistor (NMOSFET) Q1; a source of the NMOSFET Q1 is coupled to an intersection between the light-emitting unit and the second energy storage unit; a gate of the NMOSFET Q1 is coupled to the first energy storage unit; and a drain of the NMOSFET Q1 is coupled to the power supply.

16. The electronic device as described in claim 15, wherein the first energy storage unit comprises a first resistor R1, a second resistor R2, and a first capacitor C1; a first terminal N1 of the first capacitor C1 is coupled to the driving unit via the first resistor R1 and is coupled to the gate of the NMOSFET Q1, and a second terminal N2 of the first capacitor C1 is grounded and is coupled to the driving unit via the second resistor R2.

17. The electronic device as described in claim 16, wherein the light-emitting unit is a light emitting diode, an anode of the light emitting diode is coupled to the source of the NMOSFET Q1, and a cathode of the light emitting diode is grounded.

18. The electronic device as described in claim 17, wherein the second energy storage unit comprises a third resistor R3 and a second capacitor C2; a first terminal N3 of the second capacitor C2 is coupled to an intersection between the source of the NMOSFET Q1 and the anode of the light-emitting unit via the third resistor R3, and a second terminal N4 of the second capacitor C2 can be grounded.

19. The electronic device as described in claim 18, wherein the light-emitting control circuit further comprises a detection unit; a first end of the detection unit is coupled to an intersection between the first terminal N3 of the second capacitor C2 and the third resistor R3, and a second end of the detection unit is coupled to the driving unit; the detection unit is configured to detect the voltage of the first terminal N3 of the second capacitor C; the detection unit outputs a first control signal to the driving unit when the voltage of the first terminal N3 of the second capacitor C2 detected by the detection unit is less than a first predetermined value, to control the driving unit to output the first signal to the gate of the NMOSFET Q1; and the detection unit outputs the second control signal to the driving unit when the voltage of the first terminal N3 of the second capacitor C2 detected by the detection unit is more than a second predetermined value, to control the driving unit to output the second signal to the gate of the NMOSFET Q1.
